(19) United States
(12) Patent Application Publication
(10) Pub. No.: US 2026/0079733 A1
(43) Pub. Date: Mar. 19, 2026

(54) METHOD, APPARATUS, DEVICE, MEDIUM AND PROGRAM PRODUCT FOR INTERACTIVE INFORMATION PROCESSING

(71) Applicant: Beijing Zitiao Network Technology Co., Ltd., Beijing (CN)

(72) Inventors: Weizhi YAN, Beijing (CN); Longteng PENG, Beijing (CN)

(21) Appl. No.: 18/986,225

(22) Filed: Dec. 18, 2024

(30) Foreign Application Priority Data
Sep. 18, 2024 (CN) 202411304030.1

(51) Int. Cl. G06F 9/451; G06F 40/35

(52) U.S. Cl. CPC G06F 9/453; G06F 40/35

(57) ABSTRACT

This disclosure describes a method, an apparatus, a device, a computer-readable storage medium, and a computer program product for interactive information processing. The method includes the following steps: detecting to-be-evaluated interactive information of a digital assistant, the interactive information being used to comment on the digital assistant; and determining an evaluation result for the interactive information based on the interactive information and configuration information of the digital assistant, the evaluation result indicating a tendency of the interactive information to the comment on the digital assistant.

### CROSS-REFERENCE

This application claims priority to Chinese patent application No. 202411304030.1, entitled “METHOD, APPARATUS, DEVICE, MEDIUM AND PROGRAM PRODUCT FOR INTERACTIVE INFORMATION PROCESSING” filed on Sep. 18, 2024, the entire contents of which are incorporated herein by reference.

### TECHNICAL FIELD

Example embodiments of the present disclosure generally relate to the field of computers, and in particular, to a method, an apparatus, a device, a computer-readable storage medium, and a computer program product for interactive information processing.

### BACKGROUND

The digital assistant is provided to assist the user in various task processing requirements in different applications and scenarios. Digital assistants typically have intelligent dialogue and task processing capabilities. During the interaction process with the digital assistant, the user enters an interaction message and the digital assistant provides a reply message in response to the user input. As more and more digital assistants are developed and used, evaluation on dialogue quality and task processing quality of different digital assistants is a problem that needs to be concerned.

### SUMMARY

In a first aspect of the present disclosure, a method for interactive information processing is provided. The method includes: detecting to-be-evaluated interactive information of a digital assistant, the interactive information being used to comment on the digital assistant; and determining an evaluation result for the interactive information based on the interactive information and configuration information of the digital assistant, the evaluation result indicating a tendency of the interactive information to the comment on the digital assistant.

In a second aspect of the present disclosure, an apparatus for interactive information processing is provided. The apparatus includes a detecting module and a determining module, where the detecting module is configured to detect to-be-evaluated interactive information of a digital assistant, the interactive information being used to comment on the digital assistant; the determining module is configured to determine an evaluation result for the interactive information based on the interactive information and configuration information of the digital assistant, the evaluation result indicating a tendency of the interactive information to the comment on the digital assistant.

In a third aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the electronic device to perform the method of the first aspect.

In a fourth aspect of the present disclosure, a computer-readable storage medium is provided. The medium stores a computer program thereon, and when executed by the processor, the computer program implements the method in the first aspect.

In a fifth aspect of the present disclosure, a computer program product is provided, including a computer program, wherein the computer program, when executed by a processor, implements the method according to the first aspect of the present disclosure.

It should be appreciated that the content described in this section is not intended to limit critical features or essential features of the embodiments of the disclosure, nor is it intended to limit the scope of the present disclosure. Other features of the present disclosure will become readily appreciated from the following description.

### BRIEF DESCRIPTION OF DRAWINGS

The above and other features, advantages, and aspects of various embodiments of the present disclosure will become more apparent with reference to the following detailed description taken in conjunction with the accompanying drawings. In the drawings, the same or similar reference signs denote the same or similar elements, where:

FIG. 1 illustrates a schematic diagram of an example environment in which embodiments of the present disclosure can be implemented;

FIG. 2 illustrates a flowchart of a process for interactive information processing according to some embodiments of the present disclosure;

FIG. 3 illustrates a flowchart of a signaling flow for interactive information processing according to some embodiments of the present disclosure;

FIG. 4 illustrates a schematic diagram of an example of an interactive information management interface according to some embodiments of the present disclosure;

FIG. 5 is a schematic structural block diagram of an apparatus for interactive information processing according to some embodiments of the present disclosure; and

FIG. 6 illustrates a block diagram of an electronic device in which one or more embodiments of the present disclosure may be implemented.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are provided for illustrative purposes only and are not intended to limit the scope of protection of the present disclosure.

In the description of the embodiments of the present disclosure, the term “including” and the like should be understood as non-exclusive inclusion, that is, “including but not limited to”. The term “based on” should be understood as “based at least in part on.” The term “one embodiment” or “the embodiment” should be understood as “at least one embodiment”. The term “some embodiments” should be understood as “at least some embodiments”. Other explicit and implicit definitions may also be included below.

Herein, unless explicitly stated otherwise, “performing a step in response to A” does not mean that the step is performed immediately after “A”, but one or more intermediate steps may be included.

It will be appreciated that the data involved in the technical solution (including but not limited to the data itself, the obtaining or use of the data) should comply with the requirements of the corresponding legal regulations and related provisions.

It will be appreciated that, before using the technical solutions disclosed in the various embodiments of the present disclosure, the related user shall be informed of the type, usage ranges, usage scenarios, and the like of the personal information involved in this disclosure in an appropriate manner and the user's authorization shall be obtained, in accordance with relevant laws and regulations. The related users may include any type of right bodies, such as individuals, enterprises, and groups.

For example, in response to receiving an active request from a user, prompt information is sent to the related user to explicitly prompt the related user that an operation requested by the user will require obtaining and use of personal information of the related user. Thus, the related user can autonomously select, according to the prompt information, whether to provide information to software or hardware such as an electronic device, an application program, a server, or a storage medium that executes the operations of the technical solutions of the present disclosure.

As an optional but non-limiting implementation, in response to receiving an active request from the related user, prompt information is sent to the related user, for example, in the form of a pop-up window, and the pop-up window may present the prompt information in the form of text. In addition, the pop-up window may also carry a selection control for the user to select whether he/she “agrees” or “disagrees” to provide information to the electronic device.

It can be understood that the above notification and user authorization process are only illustrative, which do not limit the implementation of this disclosure. Other methods that meet relevant laws and regulations can also be applied to the implementation of this disclosure.

As used herein, the term “model” may learn association between corresponding input and output from training data, so that after the training is complete, corresponding output may be generated for given input. The generation of the model may be based on a machine learning technology. Deep learning is a machine learning algorithm that processes input and provides corresponding output by using a multi-tiered processing unit. A neural network model is one example of a model based on deep learning. Herein, “model” may also be referred to as “machine learning model,” “learning model,” “machine learning network,” or “learning network”, which may be used interchangeably herein.

A “neural network” is a deep learning-based machine learning network. The neural network is capable of processing inputs and providing respective outputs, which typically include an input layer and an output layer and one or more hidden layers between the input layer and the output layer. Neural networks used in deep learning applications typically include many hidden layers, increasing the depth of the network. Each layer of the neural network is connected in sequence such that the output of the previous layer is provided as an input to the next layer, where the input layer receives the input of the neural network and the output of the output layer serves as the final output of the neural network. Each layer of the neural network includes one or more nodes (also referred to as processing nodes or neurons), each node processing input from the previous layer.

Generally, machine learning may roughly include three phases, namely a training phase, a testing phase, and an application phase (also referred to as an inference phase). In the training phase, a given model may be trained by using a large amount of training data, constantly and iteratively updating parameter values until the model obtains consistent reasoning that meets expected goals from the training data. By training, the model may be considered as being able to learn an association between input and output from training data (also referred to as mappings of input to output). A parameter value of the trained model is determined. In the testing stage, a test input is applied to the trained model, so as to test whether the model can provide a correct output, thereby determining the performance of the model. In the application phase, the model may be configured to process actual input based on the trained parameter value to determine corresponding output.

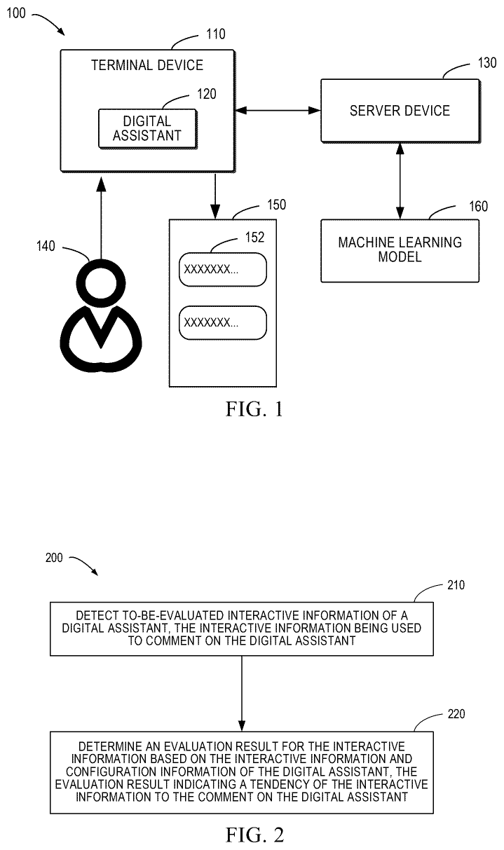

FIG. 1 illustrates a schematic diagram of an example environment 100 in which embodiments of the present disclosure can be implemented. In this example environment 100, an application is installed in the terminal device 110. A user 140 may interact with the application via the terminal device 110 and/or an attachment device of the terminal device 110.

In embodiments of the present disclosure, an application may provide a digital assistant 120 to assist the user 140 in processing tasks. The digital assistant 120 may have intelligent dialogue and task processing capabilities. Generally, the digital assistant 120 is capable of supporting the user 140 inputting questions in a natural language manner and performing tasks and providing replies based on understanding of natural language input and logical reasoning capabilities. For example, the digital assistant 120 may support content conversations with the user 140 in a text conversation service, a speech conversation service, and other modalities.

In some embodiments, the digital assistant 120 may utilize a machine learning model 160 (which may include one or more machine learning models, including, for example, a machine learning model 160-1, a machine learning model 160-2, . . . , a machine learning model 160-N, etc., where N is a positive integer. For ease of description, the one or more machine learning models are collectively referred to herein as machine learning models 160) to support interaction with the user 140. For example, the digital assistant may utilize one or more machine learning models 160 to provide a question-and-answer service to the user 140.

In the environment 100, if the digital assistant 120 is active, the terminal device 110 may present a user interface 150 of the digital assistant 120. The user interface 150 may include, for example, a dialog interface of the digital assistant 120 (where a current dialog and a historical dialog may be presented, including dialog content in text), and/or the like. In some embodiments, the terminal device 110 may present the text 152 and play the speech in the user interface 150. The speech may include, for example, a speech from the user 140 or a speech in response to the speech.

The machine learning models 160 may be a different type of model. In some embodiments, the one or more machine learning models 160 may be constructed based on a language model (LM). The machine learning model used is a content generative model capable of generating corresponding outputs based on model inputs. In some embodiments, the language model-based machine learning model can receive model inputs in a text modality (e.g., natural language and/or machine language) and/or model inputs in non-text modalities (e.g., images, voice, videos, etc.), and can generate a desired output according to the model input and prompts. The prompts herein are used to guide the machine learning model to generate output that can solve a user requirement indicated by the model input. In an application scenario for supporting a user dialog, the input of the user 140 may be provided to the machine learning model 160 as at least a portion of the model input (other parts may include prompts). This user input is considered as a question. Based on the model output, a corresponding answer may be generated to provide to the user 140.

In some embodiments, the terminal device 110 communicates with the server device 130 to implement serving of the application 120. As shown in FIG. 1, the server device 130 may call the machine learning model 160 to support the human-machine dialog function between the application 120 and the user 140 based on the output of the machine learning model 160. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 can also support any type of interface for a user (such as a “wearable” circuit, etc.). The server device 130 may be various types of computing systems/servers capable of providing computing capability, including, but not limited to, mainframes, edge computing nodes, computing devices in a cloud environment, and the like. The server device 130 may be implemented, for example, based on a cloud environment.

It should be understood that the structures and functions of the various elements in the environment 100 are described for exemplary purposes only and do not imply any limitation to the scope of the present disclosure.

As mentioned above, digital assistants are provided to assist users in various task processing requirements in different applications, scenarios. Digital assistants typically have intelligent dialogue and task processing capabilities. During the interaction with the digital assistant, the user enters an interaction message and the digital assistant provides a reply message in response to the user input.

The creator of the digital assistant may create the digital assistant with different functions according to the task requirement or for different user groups, and the conversation quality and the task processing quality of different digital assistants may also be different. The user can publish a comment content (e.g., post) on the digital assistant according to his/her use experience. The comment content can reflect the quality of the digital assistant to a certain extent, which can provide reference for quality evaluation of the digital assistant. However, there are many comments published by users and they may contain various contents and discussions. It would be desirable to be able to obtain more useful information from the comment content for the digital assistant by analyzing to help improve in the digital assistant.

In view of this, embodiments of the present disclosure provide an improved solution for interactive information processing. In this solution, to-be-evaluated interactive information of a digital assistant is detected, and the interactive information is used to comment on the digital assistant. The evaluation result for the interactive information is determined based on the interactive information and the configuration information of the digital assistant, and the evaluation result indicates a tendency of the interactive information to the comment on the digital assistant.

In the embodiment of the present disclosure, the tendency of the interactive information to the comment on the digital assistant can be determined, which may provide reference to promotion and application as well as improvement and upgrading of the digital assistant, and then improve the quality of the digital assistant.

Some example embodiments of the present disclosure will be described in detail below with reference to examples of the accompanying drawings.

FIG. 2 illustrates a flowchart of a process 200 for interactive information processing according to some embodiments of the present disclosure. The process 200 may be implemented at server device 130, which is described below in connection with FIG. 1.

At block 210 of the process 200, the server device 130 detects to-be-evaluated interactive information of the digital assistant 120, and the interactive information is used to comment on the digital assistant 120. The interactive information may be of a plurality of data types. For example, the interactive information may include text, voice, video, pictures, and the like.

There are a plurality of publication ways for interactive information, and in one example, the digital assistant 120 may be configured to have a comment entry. The terminal device 110 may publish the interactive information for the digital assistant 120 through the comment entry. For example, the digital assistant 120 may be provided with a comment area, and the user 140 may input the interactive information to the comment area through the terminal device 110 or an attachment device of the terminal device 110. The terminal device 110 sends the interactive information (for example, the comment post) to the server device 110 in response to a publishing determination operation for the interactive information. The comment post may include a comment post of the user for the digital assistant 120, or may include reply content for the comment post.

In another example, the server device 130 may receive the interactive information sent by the user 140 via the dialog interface of the digital assistant 120. For example, the user 140 may input the interactive information with respect to the interaction quality or the task execution quality of the digital assistant 120 during the interaction with the digital assistant 120. Of course, in practical applications, the interactive information may also be published in other ways or channels.

Alternatively, or additionally, the server device 130 may detect the interactive information of all users with the digital assistant 120, or may detect the interactive information of a specific user with the digital assistant 120. For example, the users may be divided into a creator, an operator, and a party that uses the digital assistant, and the server device 130 may detect the interactive information published by the creator, the operator, and the party that uses the digital assistant, or may detect the interactive information published by the party that uses the digital assistant, for example.

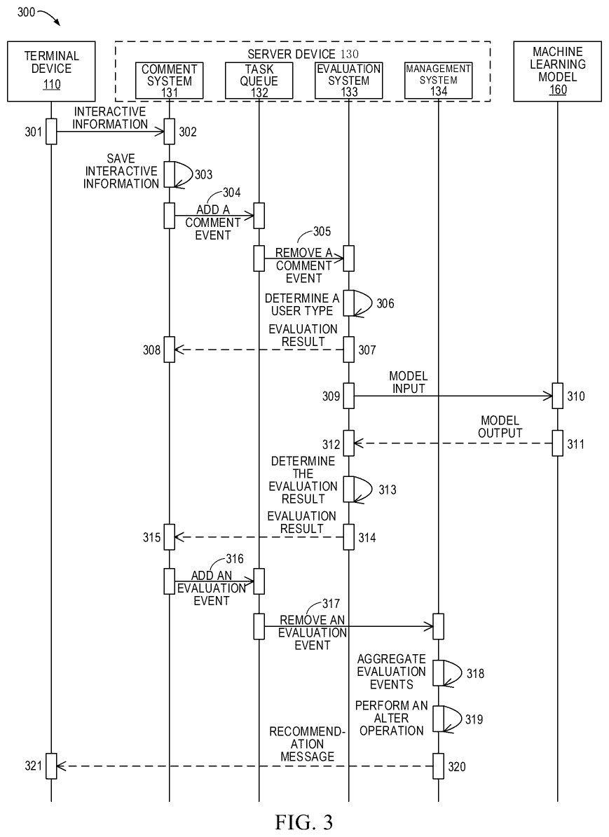

In some embodiments, the server device 130 may be deployed with a comment system, and the server device 130 may detect the interactive information for commenting the digital assistant 120 by using the comment system. To illustrate the process of detecting the interactive information by the server device 130, the following will be described with reference to FIG. 3. FIG. 3 shows a flowchart of a signaling flow 300 for user interactive information processing according to some embodiments of the present disclosure. The signaling flow 300 relates to the terminal device 110, the server device 130, and a machine learning model 160, and the server device 130 includes a comment system 131, a task queue 132, an evaluation system 133, and a management system 134. As shown in the signaling flow 300, the terminal device 110 may send (301) the interactive information for commenting the digital assistant 120 to the comment system 131 of the server device 130 in response to the comment operation by the user, and the comment system 131 may store (303) the interactive information after receiving (302) the interactive information.

At block 220 of the process 200, in response to detecting the to-be-evaluated interactive information for commenting digital assistant 120, the server device 130 determines an evaluation result for the interactive information based on the interactive information and the configuration information of the digital assistant 120. Alternatively, or additionally, the server device 130 may determine, in response to detecting new interactive information, that the to-be-evaluated interactive information is detected. The server device 130 may also periodically detect the interactive information of the digital assistant 120, and determine whether the stored interactive information include unevaluated interactive information. The configuration information of the digital assistant 120 may include, but is not limited to, a name, a number, description information, and the like of the digital assistant 120, and the description information may be used to describe a function or capability of the digital assistant 120.

The evaluation result may indicate a tendency of the interactive information to the comment on the digital assistant 120. Alternatively or additionally, the evaluation result may indicate at least that the interactive information is a positive comment or a negative comment on the digital assistant 120. It can be understood that the positive comment generally indicates that the interactive information is used for praising or approving the performance of the digital assistant 120 in terms of interaction quality, task processing quality, and the like; and the negative comment generally indicates that the interactive information is used for criticizing the performance of the digital assistant 120 in terms of interaction quality, task processing quality, and the like. Of course, the evaluation result may also indicate a neutral comment of the interactive information for the digital assistant 120, or the evaluation result may also indicate the tendency of the comment from other dimensions. Embodiments of the present disclosure are not limited in this respect. In practical applications, the comment result may indicate the tendency of the interactive information to the comment for the digital assistant 120 in various manners.

In some embodiments, the evaluation result may include a rating and an evaluation reason corresponding to the rating. Based on the score, the interactive information may be divided into a positive comment or a negative comment on the digital assistant. The evaluation reason may include an explanation to the current rating of the interactive information, an explanation of a comment opinion of the interactive information, an explanation of an advantage of the digital assistant 120, an explanation of a defect of the digital assistant 120, and the like. For example, the rating range of the rating may be determined as 1 to 100, 100 represents that the interactive information is completely positive, 1 represents that the interactive information is completely negative, and 50 represents that the interactive information is a neutral comment. Of course, the evaluation result is not limited to indicating the comment tendency by rating, and the comment tendency may also be indicated in various manners such as grade, superiority, and text description.

In some embodiments, the server device 130 may utilize the machine learning model 160 to determine an evaluation result for the interactive information. Specifically, the server device 130 may construct the model input of the machine learning model 160 based on the interactive information and the configuration information of the digital assistant 120 in response to detecting the to-be-evaluated interactive information. The model input is provided to the machine learning model 160 to obtain a model output of the machine learning model 160. Then, the server device 130 determines an evaluation result for the interactive information based on the model output. For example, the server device 130 may extract the evaluation result for the interactive information from a specific field output by the model.

In some embodiments, the server device 130 may add a comment event to the first task queue in response to detecting the to-be-evaluated interactive information. Thereafter, in response to the removal of the comment event from the first task queue, the interactive information, and the configuration information of the digital assistant 120 are provided to the machine learning model 160 to obtain an evaluation result for the interactive information.

For example, as shown in the signaling flow 300, in response to receiving (302) the interactive information, the comment system 131 may save (303) the interactive information. Thereafter, the comment system 131 may add (304) a comment event to the task queue 132. The evaluation system 133 may provide (309), in response to the removal of the comment event from the task queue 132 (305), the model input to the machine learning model 160 based on the interactive information and the configuration information of the digital assistant 120. The machine learning model 160 may feed back (311) the model output to the evaluation system 133 in response to receiving (310) the model input. The evaluation system 133 may determine (313) an evaluation result based on the model output, after which evaluation system 133 may send (314) the evaluation result to the comment system 131, and then the comment system 131 may save the evaluation result in response to receiving (315) the evaluation result. In this way, the comment system 131 and the evaluation system 133 may execute the task asynchronously, and the process of determining the evaluation result by the evaluation system 133 does not affect the comment system 131 receiving the interactive information.

In some embodiments, the server device 130 may determine a user type of a user publishing the interactive information in response to detecting the to-be-evaluated interactive information. If it is determined that the user type does not belong to a predetermined type, the predetermined evaluation result is determined as the evaluation result for the interactive information. If it is determined that the user type is a predetermined type, the interactive information and the configuration information of the digital assistant 120 are provided to the machine learning model 160 to determine the evaluation result for the interactive information by using the machine learning model 160.

The user type of the user may be divided in a plurality of dimensions, such as the user type of the user may be divided according to a relationship between the user and the digital assistant 120, an attribute of the user, and the like. For example, the user may be divided into a creator, an operator, and a party that uses the digital assistant according to the relationship between the user and the digital assistant 120, and the predetermined type may include a party that uses the digital assistant.

The predetermined evaluation result may be used to indicate that the interactive information is a neutral comment on the digital assistant 120. That is, the predetermined evaluation result indicates that the interactive information is neither a positive comment on the digital assistant 120 nor a negative comment on the digital assistant 120, but is a neutral comment between the positive comment and the negative comment. Certainly, the predetermined evaluation result may also include other content, for example, the predetermined evaluation result may also be used to indicate the user type of the user, or indicate that the user type of the user does not belong to the predetermined type.

Illustratively, as shown by the signaling flow 300, the evaluation system 133 may determine (306) a user type of the user in response to the removal of the comment event from (305) the task queue 132. If it is determined that the user who publishes the interactive information belongs to the creator or the operator, the evaluation system 133 may send (307) a predetermined evaluation result to the comment system 131, and the comment system 131 may save the rating of the interactive information. For example, an intermediate value of the rating range or a score close to the intermediate value may be determined as a rating for the interactive information. When the rating range is 1 to 100, scores of 49, 50, and 51 may be taken as ratings of the interactive information. In this way, the interactive information published by a user who do not belong to the predetermined type can be prevented from being provided to the machine learning model 160, the resource of the machine learning model 160 can be saved, and the evaluation cost of the digital assistant 120 can be reduced.

In some embodiments, the server device 110 may provide the first model input to the machine learning model 160 based on the interactive information and the configuration information of the digital assistant 120, so as to obtain the first model output of the machine learning model 160. The server device 110 may provide the second model input to the machine learning model 160 based on the interactive information and the configuration information of the digital assistant 120 in response to not detecting evaluation result for the interactive information from the first model output of the machine learning model 160, so as to obtain the second model output generated by the machine learning model 160. Then, an evaluation result for the interactive information is determined based on the second model output. That is, in a case that the evaluation of the machine learning model 160 fails, the machine learning model 160 is called again based on the interactive information and the configuration information of the digital assistant 120, and the machine learning model 160 is requested to perform evaluation again. As such, the machine learning model 160 may in some cases output the evaluation result correctly.

In some embodiments, in response to the evaluation result for the interactive information not detected from the first model output of the machine learning model, the server device 110 may generate the second model input meeting the input condition based on the interactive information, the configuration information of the digital assistant 120, and the reference information. Thereafter, a second model input meeting the input condition is provided to the machine learning model 160 to obtain a second model output generated by the machine learning model 160. The input condition may include conditions that enable the machine learning model 160 to correctly output the evaluation result. The input condition may include, but is not limited to, a content condition, a format condition, and the like for the model input. The content condition may indicate content included in the model input, e.g., the content condition may indicate that the prompt for providing to the machine learning model 160 includes one or more pieces of prompt content. A format condition may indicate a data structure, a content layout, etc., of the model input.

The reference information herein may include various information capable of providing a reference for the server device 160 and enabling the server device 160 to correctly generate the model input. For example, the model input may include prompt information conforming to JavaScript Object Notation (JSON), and the prompt information may include, for example, a task description, input content, output requirements, and the like. The task description indicates the machine learning model 160 being used to determine an evaluation result of the interactive information, and describes a requirement of determination of the evaluation result. The input content may include, for example, interactive information, configuration information of the digital assistant, and the like. The output requirements may indicate the content and format contained by the model output, such as formatting requirements indicating that the model output of the machine learning model 160 should include rating and evaluation reasons, as well as format requirement of the rating and evaluation reasons, among others. The server device 160 may generate a model input based on the interactive information and the configuration information of the digital assistant 120, and if it is determined that the generated model input does not meet the input condition (for example, lack of content), a reference case input by the model may be searched from the case set input by the model. The server device 160 may supplement the generated model input by using the reference case to form a model input that conforms to the JSON structure. The model input is then provided to the machine learning model 160. As such, the machine learning model 160 may in some cases output evaluation results correctly.

In some embodiments, the server device 130 may further perform a predetermined operation for the digital assistant 120 based on the evaluation result. In some embodiments, the server device 130 adds an evaluation event to the second task queue based on the evaluation result. The server device 130 may perform a predetermined operation on the digital assistant based on the evaluation result in response to the removal of the evaluation event from the second task queue. The second task queue and the first task queue herein may be a same task queue or different task queues. For example, as shown by a signaling flow 300, the comment system 131 adds (316) an evaluation event to task queue 132 in response to receiving (315) an evaluation result. The management system 134 performs a predetermined operation for the digital assistant in response to the removal of the evaluation event from the task queue 132 (317). As such, the comment system 131 and the management system 134 may perform task processing operations asynchronously.

The predetermined operations herein may include a variety of operations related to the evaluation results. In one example, the predetermined operation may include a recommendation operation for the digital assistant 120. The server device 130 may determine, based on an evaluation result for the interactive information within a target time range or based on evaluation results of a target number of pieces of interactive information, whether the interactive information indicating the positive comment on the digital assistant meets a recommendation condition. In response to determining that the interactive information meets the recommendation condition, a recommendation operation is performed on the digital assistant. The recommendation condition may include, but is not limited to, a positive comment number threshold, a positive rating threshold, and the like for the interactive information of the positive comment.

The target time range may be a basic time range in which the server device 130 determines whether the interactive information of the positive comment meets the recommendation condition. For example, the management system 134 may be configured to periodically determine whether the number of pieces of interactive information of positive comment in each time period exceeds a positive comment number threshold. If the number of pieces of interactive information of the positive comment exceeds the positive number threshold, it is indicated to a certain extent that the interaction quality and the task processing quality of the digital assistant 120 are better, and the management system 134 may perform the recommendation operation for the digital assistant.

The target number may be a basic number for the server device 130 to determine whether the interactive information of the positive comment meets the recommendation condition. For example, each time the number of pieces of the rating event reaches the target number, the management system 134 may be configured to determine whether the number of pieces of the interactive information of the positive comment in the target number of pieces of the interactive information exceeds the positive number threshold. If the number of pieces of the interactive information of the positive comment exceeds the positive number threshold, the management system 134 may perform the recommendation operation for the digital assistant. The recommendation operation herein may include, but is not limited to, sending a recommendation notification to the terminal device 110, performing recommendation presentation on a specific interface or platform, and the like. Certainly, the recommendation operation may further include other recommendation operations, and in actual application, any appropriate recommendation operation may be selected according to actual needs to recommend the digital assistant 120. In this way, promotion and application of the digital assistant 120 are facilitated.

In another example, the predetermined operation may include an alert operation for the digital assistant 120. The server device 130 may determine, based on an evaluation result for the interactive information within a target time range or based on evaluation results of a target number of pieces of interactive information, whether the interactive information indicating the negative comment on the digital assistant meets an alert condition. Then, in response to determining that the interactive information meets the alert condition, an alert operation is performed on the digital assistant. The alert condition may include, but is not limited to, a negative comment number threshold, a negative rating threshold, and the like for the interactive information of the negative comment. For example, it may be determined whether the number of pieces of the interactive information of the negative comment exceeds a negative comment number threshold, and if yes, it is determined that the alert condition is met. For another example, it may be determined whether an average rating or the lowest rating of the interactive information of the negative comment is lower than a negative rating threshold, and if so, it is determined that the alert condition is met. The alert operation herein may be an alert operation for an operator, or may be an alert operation for a creator.

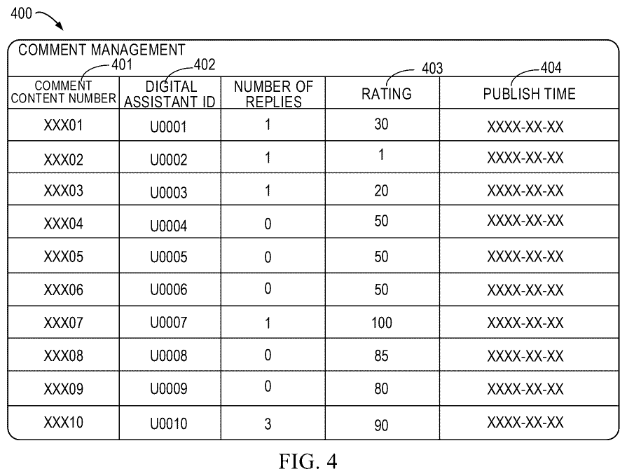

For example, as shown in FIG. 4, FIG. 4 is a schematic diagram of an example 400 of an interactive information management interface according to some embodiments of the present disclosure. Example 400 includes information such as an interactive information number 401 of interactive information, a digital assistant number (ID) 402, the number of returns, a rating 403, and a publishing time 404. Certainly, the comment management interface may further include, for example, a number, a name, and the like of the digital assistant for the interactive information. The management system 134 may aggregate (318) evaluation results within the target time range (e.g., within a particular time range prior to the current time) based on the publication time 404 in response to the removal of evaluation event from the task queue 132. The number of pieces of interactive information of the positive comment and the number of pieces of the interactive information of the negative comment within the target time range may be determined according to the rating 403.

As shown by the signaling flow 300, if the number of pieces of the interactive information of the negative comments exceeds the negative number threshold, the management system 134 performs (319) the alert operation. If the number of pieces of the interactive information of the positive comment exceeds the positive number threshold, the management system 134 may send (320) a recommendation message to the terminal device 110. The terminal device 110 receives (321) the recommendation message, and may present the recommendation message. In this way, the promotion and application as well as the improvement and upgrading of the digital assistant can be facilitated. It should be noted that the terminal device 110 receiving the recommendation message and the terminal device 110 publishing the interactive information may be the same terminal device or different terminal devices.

In yet another example, the predetermined operation may include an operation of feeding back an evaluation result to a creator of the digital assistant. In this way, a reference may be provided for the promotion and improvement by the creator for the digital assistant 120, which is beneficial to improving the quality of the digital assistant 120. For example, the server device 110 may feed back an evaluation result to the creator in response to the request of the creator, the interactive information of the positive comment triggering the recommendation condition, the interactive information of the negative comment triggering the recommendation condition, and the like.

It should be understood that the above predetermined operations are merely exemplary, and it should not be understood that the predetermined operation is limited to the above operations. In practical applications, any appropriate operation may be performed on the digital assistant 120 according to the evaluation result, and the operation types of the predetermined operations are not limited herein.

In conclusion, according to the embodiments of the present disclosure, the tendency of a comment of the interactive information on digital assistant may be determined, reference may be provided for promotion and application as well as improvement and upgrading of the digital assistant, and then the quality of the digital assistant is improved.

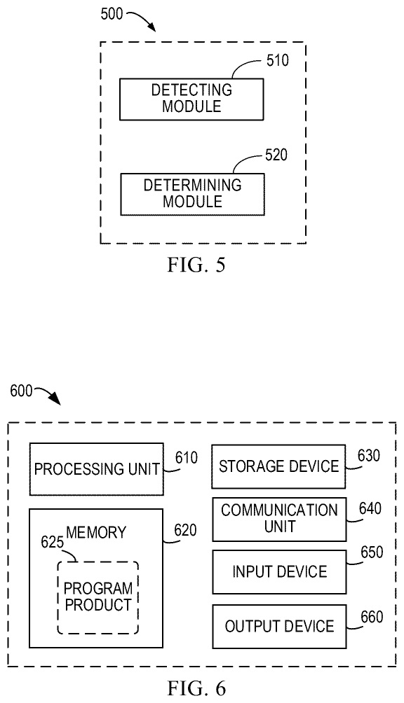

Embodiments of the present disclosure also provide a corresponding apparatus for implementing the above method or process. FIG. 5 is a schematic structural block diagram of an apparatus 500 for interactive information processing according to some embodiments of the present disclosure. For example, the apparatus 500 may be implemented in or included in the server device 130. The various modules/components in the apparatus 500 may be implemented by hardware, software, firmware, or any combination thereof.

As shown, the apparatus 500 may include a detection module 510 and a determination module 520. The detection module 510 is configured to detect to-be-evaluated interactive information of a digital assistant, the interactive information being used to comment on the digital assistant; and the determining module 520 is configured to determine an evaluation result for the interactive information based on the interactive information and configuration information of the digital assistant, the evaluation result indicating a tendency of the interactive information to the comment on the digital assistant.

In some embodiments, the determining module 520 is further configured to: in response to detecting the to-be-evaluated interactive information, a comment event to a first task queue; and in response to the removal of the comment event from the first task queue, provide the interactive information and the configuration information of the digital assistant to a machine learning model to obtain the evaluation result for the interactive information.

In some embodiments, the determining module 520 is further configured to: in response to detecting the to-be-evaluated interactive information, determine a user type of a user publishing the interactive information; and in response to the user type being a predetermined type, provide the interactive information and the configuration information of the digital assistant to a machine learning model to determine the evaluation result for the interactive information by using the machine learning model.

In some embodiments, the determining module 520 is further configured to: in response to the user type not belonging to the predetermined type, determine a predetermined evaluation result as the evaluation result for the interactive information.

In some embodiments, the determining module 520 is further configured to: provide first model input to a machine learning model based on the interactive information and the configuration information of the digital assistant, to obtain first model output of the machine learning model; in response to the evaluation result for the interactive information not detected from the first model output of the machine learning model, provide second model input to the machine learning model based on the interactive information and the configuration information of the digital assistant, to obtain second model output generated by the machine learning model; and determine the evaluation result for the interactive information based on the second model output.

In some embodiments, the determining module 520 is further configured to: in response to the evaluation result for the interactive information not detected from the first model output of the machine learning model, generate second model input meeting an input condition based on the interactive information, the configuration information of the digital assistant, and reference information; and provide the second model input to the machine learning model to obtain the second model output generated by the machine learning model.

In some embodiments, the evaluation result includes a rating and an evaluation reason corresponding to the rating, and the rating indicates that the interactive information is a positive comment or a negative comment on the digital assistant.

In some embodiments, the apparatus 500 further includes an execution module configured to perform a predetermined operation for the digital assistant based on the evaluation result.

In some embodiments, the execution module is further configured to: add an evaluation event to the second task queue based on the evaluation result; and in response to the removal of the evaluation event from the second task queue, perform the predetermined operation for the digital assistant based on the evaluation result.

In some embodiments, the execution module is further configured to: in response to determining, based on the evaluation result, that the interactive information for a positive comment on the digital assistant meets a recommendation condition, perform a recommendation operation for the digital assistant; or in response to determining, based on the evaluation result, that the interactive information for a negative comment on the digital assistant meets an alert condition, perform an alert operation for the digital assistant; or feed back the evaluation result to a creator of the digital assistant.

In some embodiments, the execution module is further configured to: feed back the evaluation result to a creator of the digital assistant.

The units and/or modules included in the apparatus 500 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 500 may be implemented, at least in part, by one or more hardware logic components. By way of example and not limitation, exemplary types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 6 illustrates a block diagram of an electronic device 600 in which one or more embodiments of the present disclosure may be implemented. It should be understood that the electronic device 600 illustrated in FIG. 6 is merely exemplary and should not constitute any limitation on the functionality and scope of the embodiments described herein. The electronic device 600 shown in FIG. 6 may include or be implemented as the server device of FIG. 1 or the device 500 of FIG. 5.

As shown in FIG. 6, the electronic device 600 is in the form of a general-purpose electronic device. Components of the electronic device 600 may include, but are not limited to, one or more processors or processing units 610, a memory 620, a storage device 630, one or more communications units 640, one or more input devices 650, and one or more output devices 660. The processing unit 610 may be an actual or virtual processor and can perform various processes according to programs stored in the memory 620. In a multiprocessor system, a plurality of processing units execute computer executable instructions in parallel, so as to improve the parallel processing capability of the electronic device 600.

The electronic device 600 typically includes a number of computer storage media. Such media may be any available media that are accessible by electronic device 600, including, but not limited to, volatile and non-volatile media, removable and non-removable media. The memory 620 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium such as a flash drive, a magnetic disk, or any other medium that can be used to store information and/or data and that can be accessed within the electronic device 600.

The electronic device 600 may further include additional removable/non-removable, volatile/nonvolatile storage media. Although not shown in FIG. 6, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 implements communication with other electronic devices through a communication medium. In addition, functions of components of the electronic device 600 may be implemented by a single computing cluster or a plurality of computing machines, and these computing machines can communicate through a communication connection. Thus, the electronic device 600 may operate in a networked environment using logical connections to one or more other servers, network personal computers (PCs), or another network node.

The input device 650 may be one or more input devices such as a mouse, keyboard, trackball, etc. The output device 660 may be one or more output devices such as a display, speaker, printer, etc. The electronic device 600 may also communicate with one or more external devices (not shown) such as a storage device, a display device, or the like through the communication unit 640 as required, and communicate with one or more devices that enable a user to interact with the electronic device 600, or communicate with any device (e.g., a network card, a modem, or the like) that enables the electronic device 600 to communicate with one or more other electronic devices. Such communication may be performed via an input/output (I/O) interface (not shown).

According to an exemplary implementation of the present disclosure, a computer readable storage medium is provided, on which a computer-executable instruction is stored, wherein the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some updated implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for interactive information processing, comprising:
detecting to-be-evaluated interactive information of a digital assistant, the interactive information being used to comment on the digital assistant; and
determining an evaluation result for the interactive information based on the interactive information and configuration information of the digital assistant, the evaluation result indicating a tendency of the interactive information to the comment on the digital assistant.

2. The method of claim 1, wherein determining the evaluation result for the interactive information comprises:
in response to detecting the to-be-evaluated interactive information, adding a comment event to a first task queue; and
in response to removal of the comment event from the first task queue, providing the interactive information and the configuration information of the digital assistant to a machine learning model to obtain the evaluation result for the interactive information.

3. The method of claim 1, wherein determining the evaluation result for the interactive information comprises:
in response to detecting the to-be-evaluated interactive information, determining a user type of a user publishing the interactive information; and
in response to the user type being a predetermined type, providing the interactive information and the configuration information of the digital assistant to a machine learning model to determine the evaluation result for the interactive information using the machine learning model.

4. The method of claim 3, wherein determining the evaluation result for the interactive information further comprises:
in response to the user type not belonging to the predetermined type, determining a predetermined evaluation result as the evaluation result for the interactive information.

5. The method of claim 1, wherein determining the evaluation result for the interactive information comprises:
providing a first model input to a machine learning model based on the interactive information and the configuration information of the digital assistant, to obtain a first model output of the machine learning model;
in response to the evaluation result for the interactive information not detected from the first model output of the machine learning model, providing a second model input to the machine learning model based on the interactive information and the configuration information of the digital assistant, to obtain a second model output generated by the machine learning model; and
determining the evaluation result for the interactive information based on the second model output.

6. The method of claim 5, wherein providing the second model input to the machine learning model based on the interactive information and the configuration information of the digital assistant comprises:
in response to the evaluation result for the interactive information not detected from the first model output of the machine learning model, generating a second model input meeting an input condition based on the interactive information, the configuration information of the digital assistant, and reference information; and
providing the second model input to the machine learning model to obtain the second model output generated by the machine learning model.

7. The method of claim 1, wherein the evaluation result comprises a rating and an evaluation reason corresponding to the rating, and the rating indicates that the interactive information is a positive comment or a negative comment on the digital assistant.

8. The method of claim 1, further comprising:
performing a predetermined operation for the digital assistant based on the evaluation result.

9. The method of claim 8, wherein performing the predetermined operation for the digital assistant comprises:
adding an evaluation event to a second task queue based on the evaluation result; and
in response to a removal of the evaluation event from the second task queue, performing the predetermined operation for the digital assistant based on the evaluation result.

10. The method of claim 8, wherein performing the predetermined operation for the digital assistant comprises at least one of:
in response to determining, based on the evaluation result, that the interactive information for a positive comment on the digital assistant meets a recommendation condition, performing a recommendation operation for the digital assistant; or
in response to determining, based on the evaluation result, that the interactive information for a negative comment on the digital assistant meets an alert condition, performing an alert operation for the digital assistant; or
feeding back the evaluation result to a creator of the digital assistant.

11. An electronic device, comprising:
at least one processor; and
at least one memory coupled to the at least one processor and storing instructions for execution by the at least one processor, the instructions, when executed by the at least one processor, causes the electronic device to perform operations for interactive information processing, comprising:
detecting to-be-evaluated interactive information of a digital assistant, the interactive information being used to comment on the digital assistant; and
determining an evaluation result for the interactive information based on the interactive information and configuration information of the digital assistant, the evaluation result indicating a tendency of the interactive information to the comment on the digital assistant.

12. The electronic device of claim 11, wherein determining the evaluation result for the interactive information comprises:
in response to detecting the to-be-evaluated interactive information, adding a comment event to a first task queue; and
in response to removal of the comment event from the first task queue, providing the interactive information and the configuration information of the digital assistant to a machine learning model to obtain the evaluation result for the interactive information.

13. The electronic device of claim 11, wherein determining the evaluation result for the interactive information comprises:
in response to detecting the to-be-evaluated interactive information, determining a user type of a user publishing the interactive information; and
in response to the user type being a predetermined type, providing the interactive information and the configuration information of the digital assistant to a machine learning model to determine the evaluation result for the interactive information using the machine learning model.

14. The electronic device of claim 13, wherein determining the evaluation result for the interactive information comprises:
in response to the user type not belonging to the predetermined type, determining a predetermined evaluation result as the evaluation result for the interactive information.

15. The electronic device of claim 11, wherein determining the evaluation result for the interactive information comprises:
providing a first model input to a machine learning model based on the interactive information and the configuration information of the digital assistant, to obtain a first model output of the machine learning model;
in response to the evaluation result for the interactive information not detected from the first model output of the machine learning model, providing a second model input to the machine learning model based on the interactive information and the configuration information of the digital assistant, to obtain a second model output generated by the machine learning model; and
determining the evaluation result for the interactive information based on the second model output.

16. The electronic device of claim 15, wherein providing the second model input to the machine learning model based on the interactive information and the configuration information of the digital assistant comprises:
in response to the evaluation result for the interactive information not detected from the first model output of the machine learning model, generating a second model input meeting an input condition based on the interactive information, the configuration information of the digital assistant, and reference information; and
providing the second model input to the machine learning model to obtain the second model output generated by the machine learning model.

17. The electronic device of claim 11, wherein the evaluation result comprises a rating and an evaluation reason corresponding to the rating, and the rating indicates that the interactive information is a positive comment or a negative comment on the digital assistant.

18. The electronic device of claim 11, wherein the operations comprise:
performing a predetermined operation for the digital assistant based on the evaluation result.

19. The electronic device of claim 18, wherein performing the predetermined operation for the digital assistant comprises:
adding an evaluation event to a second task queue based on the evaluation result; and
in response to a removal of the evaluation event from the second task queue, performing the predetermined operation for the digital assistant based on the evaluation result.

20. A non-transitory computer-readable storage medium having stored thereon a computer program, the computer program executable by at least one processor to perform operations for interactive information processing, comprising:
detecting to-be-evaluated interactive information of a digital assistant, the interactive information being used to comment on the digital assistant; and
determining an evaluation result for the interactive information based on the interactive information and configuration information of the digital assistant, the evaluation result indicating a tendency of the interactive information to the comment on the digital assistant.
